(19) United States
(12) Patent Application Publication
(10) Pub. No.: US 2006/0240871 A1
(43) Pub. Date: Oct. 26, 2006

(54) System and method for audible error messaging of an incorrect optical medium

(76) Inventors: David Konetski, Austin, TX (US); Thomas L. Pratt, Austin, TX (US)

Correspondence Address: HAMILTON & TERRILE, LLP, P.O. BOX 203518, AUSTIN, TX, 78720, US

(21) Appl. No.: 11/112,251

(22) Filed: Apr. 22, 2005

(51) Int. Cl. H04B 1/38

(52) U.S. Cl. 455/563

(57) ABSTRACT

An error engine associated with an optical disc drive plays an audible voice error message if an optical medium inserted in the optical drive based system is incompatible with the optical drive based system. For instance, if an optical medium with video navigation is input into an optical drive based system that supports only audio navigation, a voice message states, “this video disc is not playable in an audio system.” Plural types of voice messages may be selected to address plural types of incompatibilities. The voice messages are stored on the optical medium, in the optical drive based system or at a network location accessible by the optical drive based system.

### BACKGROUND OF THE INVENTION

1. Field of the Invention

The present invention relates in general to the field of information handling system optical medium playback, and more particularly to a system and method for audible error messaging of an incorrect optical medium.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems use and generate a considerable amount of information, especially in storing and presenting audiovisual information such as videos or music. Optical media provide convenient and portable storage of audiovisual information. Initially, Compact Disc (CD) optical media were developed to store data and audio information, such as record albums. CD media use an infrared laser to read and write information and generally store less than 1 gigabyte of information. Digital Versatile Disc optical media were developed next for storing data and video information, such as commercial movies. DVD media use a red laser to read and write information and, because of the shorter wavelength of the red versus the infrared laser, are generally able to store approximately 4 gigabytes of information. Recently a new optical media has been developed that use a blue laser to read and write information. The Blu-ray or High Definition DVD optical media store in excess of 20 gigabytes of information and are intended for storage and delivery of HD-TV movies and other digital content.

As the Blu-ray Disc Association has developed formats for storing information on blue laser optical media, interest has grown in the development of video-centric formats that store videos, audio-centric formats that store music as a replacement for CDs, and combined video and audio formats that store both kinds of information. To provide an improved user experience, each of these formats will have its own navigation scheme. One aspect of defining an audio scheme is ensuring that users can navigate through the content of a disc without a video display. The ability to navigate the disc using an audio versus video navigation scheme is selected at the time of creation of the optical medium disc. Discs that are created with an audio navigation scheme may be played on either an audio-only device or on a video device, however, discs that are created with a video navigation scheme can only play on video-enabled devices. One difficulty that may arise is that discs having video navigation that are inserted into an audio-only player will fail to playback. The player device will have to inform the user of the error. In CD player devices, errors in inserted discs are usually indicated with a blinking LED or a single line display that states error. In simple CD devices, the disc simply fails to play and the user is left to figure out the reason for the failure on his own.

### SUMMARY OF THE INVENTION

Therefore a need has arisen for a system and method which provides a voice error message if an optical drive based system receives an incompatible optical medium.

In accordance with the present invention, a system and method are provided which substantially reduce the disadvantages and problems associated with previous methods and systems for indicating incompatibility of an optical medium with an optical drive based system. If an optical drive based system detects that an inserted optical medium is incompatible to play on the optical drive based system, a voice message issues from the optical drive based system to indicate the incompatibility.

More specifically, an error engine operating on an optical drive based system compares the format of an inserted optical medium with formats compatible with the optical drive based system and issues an audible voice error message if the inserted optical medium is incompatible with the optical drive based system. For example, a blue laser optical drive based system that plays with audio navigation will issue a voice error message if an optical medium is inserted that is formatted with video navigation. The error engine detects plural different types of incompatibility errors and plays a voice message associated with each detected type. The voice error message is stored on the optical medium and retrieved by the optical drive based system if an incompatibility is detected. Alternatively, the voice error message is stored in the optical drive based system or at a network location accessible by the optical medium if an incompatibility error is detected.

The present invention provides a number of important technical advantages. One example of an important technical advantage is that users are provided with voice information in the event of an incompatibility of an optical medium inserted into an optical drive based system configured to play with audio navigation. Users are thus more easily able to discern the difficulty encountered with playing an optical medium on an optical drive based system where no or limited visual display is available. Audible voice error messages improve safety by decreasing the distraction to a user in operation of an optical drive based system, such as when driving a vehicle, in reduced light or when the optical drive based system is in a different location. Further, issuing error messages that identify the type of error allow the user to determine whether the error is correctable without forcing the user to view a display.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having an optical drive based system with voice error messaging; and

FIG. 2 depicts a flow diagram of a process for indicating an optical medium incompatibility with an optical drive based system.

### DETAILED DESCRIPTION

Voice error messages issued from an information handling system optical drive based system indicate incompatibility of an optical medium without requiring a visual display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

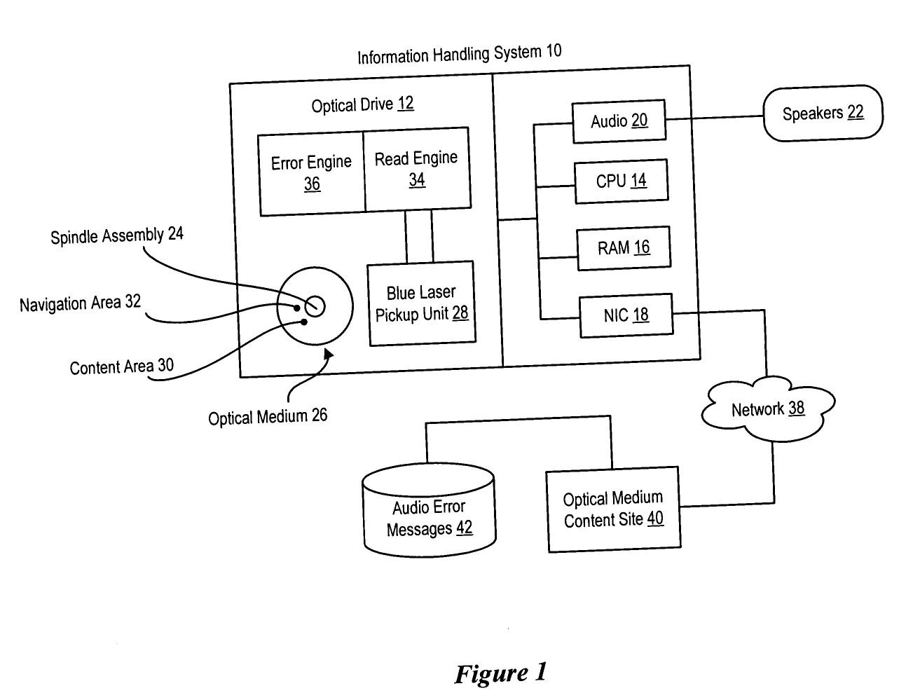

Referring now to FIG. 1, a block diagram depicts an information handling system 10 having an optical drive based system 12, the information handling system supporting voice error messaging. Information handling system 10 has processing components for processing information, such as CPU 14, RAM 16, a network interface card (NIC) 18 and an audio card 20. Error information received from optical drive based system 12 is managed by CPU 14, such as under direction of an operating system, and transformed to audible sounds that play on speakers 22, such as by a CODEC located on audio card 20. Information handling system 10 may be a general purpose system that performs multiple functions, such as desktop or portable system, or may be designed specifically to play audio files from an optical medium.

Optical drive based system 12 includes a spindle assembly 24 that rapidly spins an optical medium 26 relative to an optical pickup unit 28. Optical pickup unit 28 includes one or more lasers that illuminate optical medium 26 and measures the reflectivity of the optical medium, such as a blue laser for Blu-ray media, a red laser for DVD media and/or an infrared laser for CD media. Information is stored on the optical medium by varying the reflectivity of the material to indicate ones and zeros. For instance, a content area 30 of optical medium 26 stores content, such as video files or audio files. A navigation area 32 stores format information used to navigate through the content. For instance, audio navigation formatting allows an optical drive based system to navigate audio files stored in content area 30 and video navigation formatting allows an optical drive based system to navigate video files stored in content area 30. Audio navigation formatting is generally accessible by optical drive based systems designed to present either audio or video information. Video navigation formatting is generally incompatible with optical drive based systems designed only to present audio information. In some instances, both audio and video navigation are included with the audio-only optical drive based systems able to interact with the audio navigation formatting but not the video formatting.

When an optical medium 26 is inserted in an optical drive based system 12, optical pickup unit 28 initiates operation at the inner portion of optical medium 26 to determine the type of optical medium. A read engine 34 sets parameters for the laser to illuminate the optical medium to read information based on the type of optical medium that is inserted. Read engine 34 reads the navigation format from the navigation area 32 to allow a user to navigate the content appropriately. An error engine 36 compares the type of optical medium determined by read engine 34, including the navigation formatting, with the types of optical media supported by read engine 34 and issues an audible voice error message if the inserted optical medium is not compatible with read engine 34. For example, for optical drive based systems 12 that do not support video navigation, if the inserted optical medium has video navigation and lacks audio navigation, error engine 36 issues a voice message from speaker 22 that states, “this video disc is not playable in an audio system.” In one embodiment, the voice error message is stored as an audio file on the optical medium and retrieved by error engine 36 when an incompatibility is determined. In an alternative embodiment, the error message is stored in persistent memory of optical drive based system 12, such as flash memory, and retrieved for playback at an incompatibility determination. In another alternative embodiment, an applet, such as a Java applet, stored on the optical medium is retrieved by error engine 36 and used to interface through NIC 18 with network 38 to obtain the voice error message from optical medium content site 40, which maintains a variety of messages in an audio error message database 42.

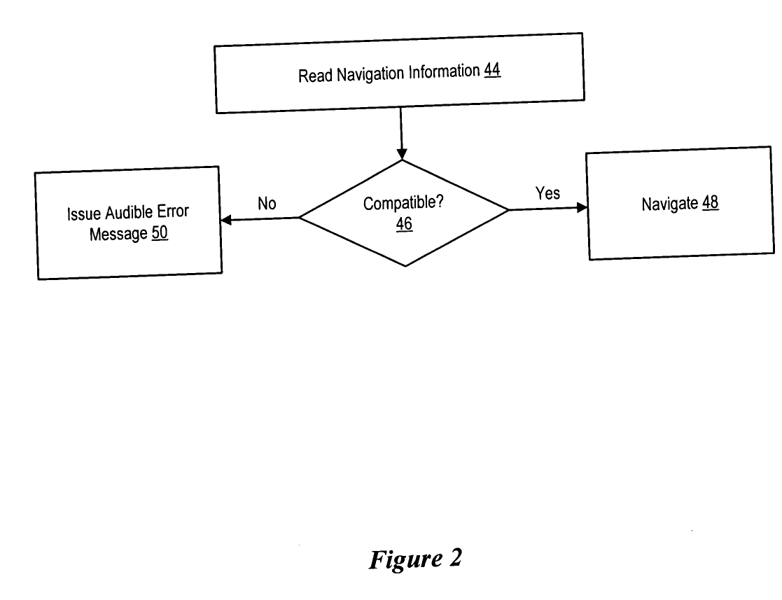

Referring now to FIG. 2, a flow diagram depicts a process for indicating an optical medium incompatibility with an optical drive based system by a voice error message. The process begins at step 44 with the reading of navigation information from the optical medium. At step 46, a determination is made of whether the optical medium is compatible with the optical drive based system. If, for instance the optical drive based system is unable to read any information from the optical medium, the optical medium is determined to be incompatible. If the optical drive based system is capable of audio navigation and does not support video navigation, then the optical medium is determined incompatible if the navigation information is video navigation information. If the optical drive based system is both audio and video navigation enabled, then the optical medium is determined compatible whether it uses audio or video navigation. If the determination at step 46 is that the optical medium is compatible with the optical drive based system, the process continues to step 48 for normal navigation through the content. If the determination at step 46 is that the optical medium is not compatible with the optical drive based system, the process continues to step 50 for issuance of an audible voice error message. The voice message may be selected from plural messages to address the type of incompatibility that is determined. For instance, the voice message states, “the drive cannot read from the disc, the disc may be faulty” if no navigation information is found on the optical medium. Alternatively, the voice message states “this is a video disc” if video navigation information is found. Advantageously, the optical medium or the optical drive based system can store different types of error voice messages for specific situations as desired by the content provider or drive manufacturer. Additionally, non-error voice messages may be included to confirm user selections. For instance, pressing the play button can result in a voice message that states, “playing now” or “playing track 3” so that the user does not have to visually confirm selected operations.

Although the present invention has been described in detail, it should be understood that various changes, substitutions and alterations can be made hereto without departing from the spirit and scope of the invention as defined by the appended claims.

What is claimed is:

1. A method for playing an optical medium on an optical drive based system, the method comprising:
inserting the optical medium into the optical drive based system;
searching the optical medium with the optical drive based system to attempt to identify the formatting of the optical medium;
determining that the formatting of the optical medium is incompatible with the optical drive based system; and
issuing an audible voice error message of the incompatibility from the optical drive based system.

2. The method of claim 1 wherein searching the optical medium further comprises failing to identify the formatting of the optical medium.

3. The method of claim 1 wherein searching the optical medium further comprises identifying the formatting of the optical medium as video navigation formatting, the optical drive based system configured to play optical media having audio navigation formatting.

4. The method of claim 1 further comprising:
determining that the incompatibility is associated with one of plural types of errors;
selecting an error message associated with the determined type of error; and
playing the error message to audibly identify the type of error.

5. The method of claim 1 further comprising:
retrieving the error message from the optical medium to issue the audible error message.

6. The method of claim 1 further comprising:
retrieving the error message from memory of the optical drive based system to issue the audible error message.

7. The method of claim 1 further comprising:
interfacing with a network; and
retrieving the error message from the network to issue the audible error message.

8. The method of claim 7 wherein interfacing with a network further comprises:
retrieving a network address from the optical medium; and
interfacing with the retrieved network address through the network.

9. An optical drive based system comprising:
an optical pickup unit operable to illuminate an optical medium with laser light and detect reflectivity of the optical medium to determine information stored on the optical medium;
a spindle assembly operable to spin the optical medium proximate the optical pickup unit;
a read engine interfaced with the optical pickup unit and operable to determine the information from the reflectivity; and
an error engine associated with the read engine and operable to compare information determined from the optical medium with predetermined information to determine the compatibility of the optical medium, the error engine further operable to issue an voice error message if the optical medium is incompatible.

10. The optical drive based system of claim 9 wherein the error engine determines the compatibility of the optical medium by comparing formatting of the optical medium with formatting supported by the read engine.

11. The optical drive based system of claim 10 wherein the supported formatting comprises audio navigation and the optical medium formatting comprises video navigation.

12. The optical drive based system of claim 10 wherein the formatting of the optical medium is not determinable by the error engine.

13. The optical drive based system of claim 10 wherein the optical pickup unit comprises a blue laser to illuminate the optical medium with blue laser light.

14. The optical drive based system of claim 9 wherein the error engine is further operable to classify the type of optical medium incompatibility from plural types of optical medium incompatibilities and to issue a voice error message that identifies the type of incompatibility.

15. The optical drive based system of claim 9 wherein the voice error message is stored on the optical medium, the error engine retrieving the error message from the optical medium.

16. The optical drive based system of claim 9 wherein the voice error message is stored on the optical drive based system, the error engine retrieving the error message from the optical drive based system.

17. The optical drive based system of claim 9 wherein the voice error message is stored at a network location, the error engine retrieving the error message through a network from the network location.

18. A system for indicating an optical medium incompatibility with an optical drive based system, the system comprising:
an error engine operable to determine the incompatibility of an optical medium inserted in an optical drive based system; and
at least one voice error message associated with the error engine;
wherein the error engine audibly plays the voice error message to indicate the incompatibility.

19. The system of claim 18 wherein the incompatibility comprises a video navigation associated with the optical medium.

20. The system of claim 19 wherein the voice error message is stored on the optical medium.
